(19) United States
(12) Patent Application Publication
(10) Pub. No.: US 2013/0166246 A1
(43) Pub. Date: Jun. 27, 2013

(54) Sensor-assisted Improvement of Timing-Based Positioning Accuracy

(71) Applicants: Seppo Rousu, Oulu (FI); Antti Immonen, Helsinki (FI); Christopher Callender, Kinross (GB)

(72) Inventors: Seppo Rousu, Oulu (FI); Antti Immonen, Helsinki (FI); Christopher Callender, Kinross (GB)

(73) Assignee: Renesas Mobile Corporation

(21) Appl. No.: 13/342,371

(22) Filed: Jan. 3, 2012

(30) Foreign Application Priority Data
Dec. 22, 2011 (GB) 1122207.2

(51) Int. Cl. G06F 15/00; G01P 15/00

(52) U.S. Cl. 702/141; 702/150

(57) ABSTRACT

There are provided measures for enabling a sensor-assisted improvement of timing-based positioning accuracy. Such measures may exemplarily include measuring a first timing value for timing-based positioning calculation on the basis of a first positioning-related signal at a first time, measuring a second timing value for timing-based positioning calculation on the basis of a second positioning-related signal at a second time, deriving movement information indicative of a movement of an apparatus to be positioned during a time interval from the first time to the second time, and utilizing the measured first timing value, the measured second timing value and the derived movement information for timing-based positioning calculation relating to the apparatus to be positioned at a network side.

### FIELD OF THE INVENTION

The present invention relates to a sensor-assisted improvement of timing-based positioning accuracy. More specifically, the present invention relates to measures (including methods, apparatuses and computer program products) for enabling a sensor-assisted improvement of timing-based positioning accuracy.

### BACKGROUND

In modern and future communication systems, location services and location-based services (LCS) are gaining more attention and importance. In order to enable provision of location services and location-based services for terminals in modern and future communication systems, an accurate positioning of the terminals is vital. An accurate positioning is for example particularly valuable in emergency- and/or public safety-related use cases, under indoor conditions, urban canyons, tunnels, parking halls, subways, vehicles, and the like.

In the framework of 3GPP standardization, LTE control plane signaling support for LCS is introduced from 3GPP Release 9 onwards. Therein, assisted satellite positioning is specified as a primary positioning/localization technique, while both a cell ID based positioning and OTDOA-based positioning are specified as fallback positioning/localization techniques for the event that the terminal lacks satellite positioning capability or the assisted satellite positioning fails e.g. due to non-availability of a required number of positioning satellite signals.

The assisted satellite positioning is essentially based on at least four positioning satellite signals of GPS or any other satellite-based positioning system, while the network can provide assistance data for a reliable fix of the position.

The cell ID based positioning and enhancements thereof are essentially based on the fact that the responsible server (e.g. E-SMLC) knows the geographical locations of the cells, that the timing advance can be used to find a terminal's distance from each base station antenna in the vicinity, and that neighbor cell measurements and the like can be used to increase the accuracy of the positioned. That is to say, the consideration of neighbor cells enhances accuracy of positioning.

The OTDOA-based positioning is essentially based on the measurement of an observed time difference of arrival (OTDOA) on the basis of a positioning-related signal. In this regard, a terminal's position can be multi-laterated (mostly tri-laterated) with the knowledge of multiple (mostly three or more) base stations' transmit timings and their geographical locations and received time differences of at least two other cells relative to the serving cell of the terminal. In this regard, the terminal must detect positioning-related signals from multiple (mostly at least three) base stations in the vicinity.

Generally, when an increased accuracy of positioning results is desired in a specific communication system, the accuracy of positioning of at least one of the positioning/localization techniques specified for that specific communication system is to be improved. In view of the above, in the context of a 3GPP-based LTE communication system, the accuracy of positioning of at least one of assisted satellite positioning, the cell ID based positioning and the OTDOA-based positioning is to be improved.

The accuracy of positioning of the assisted satellite positioning and the cell ID based positioning may not be easily improved without requiring fundamental changes to the functional and/or structural configuration of the underlying satellite-based positioning system and communication system, respectively. Therefore, when an increased accuracy of positioning results is desired in a 3GPP-based LTE communication system, the accuracy of positioning of the OTDOA-based positioning is preferably to be improved.

Generally speaking, the positioning accuracy of a timing-based positioning technique (e.g. the OTDOA-based positioning technique) may typically be improved, while the positioning accuracy of infrastructure-based positioning technique is typically difficult to improve without effecting fundamental modifications to the underlying infrastructure.

Accordingly, in order to increase accuracy of positioning results in a specific communication system, it is desirable to improve the positioning accuracy of a timing-based positioning technique therein, which may typically be achieved when improving underlying timing information and/or timing measurements.

Thus, there is a desire to improve timing-based positioning accuracy.

### SUMMARY

Various exemplary embodiments of the present invention aim at addressing at least part of the above issues and/or problems and drawbacks.

Various aspects of exemplary embodiments of the present invention are set out in the appended claims.

According to an exemplary aspect of the present invention, there is provided a method comprising measuring a first timing value for timing-based positioning calculation on the basis of a first positioning-related signal at a first time, measuring a second timing value for timing-based positioning calculation on the basis of a second positioning-related signal at a second time, deriving movement information indicative of a movement of an apparatus to be positioned during a time interval from the first time to the second time, and signaling the measured first timing value, the measured second timing value and the derived movement information towards a network side for timing-based positioning calculation.

According to an exemplary aspect of the present invention, there is provided a method comprising receiving a first timing value for timing-based positioning calculation relating to a first time, a second timing relating to a second time, and movement information indicative of a movement of an apparatus to be positioned during a time interval from the first time to the second time, and performing timing-based positioning calculation relating to the apparatus to be positioned on the basis of the received first timing value, second timing value, and movement information.

According to an exemplary aspect of the present invention, there is provided an apparatus comprising at least one processor, at least one memory including computer program code, and at least one interface configured for communication with at least another apparatus, the at least one processor, with the at least one memory and the computer program code, being configured to cause the apparatus to perform: measuring a first timing value for timing-based positioning calculation on the basis of a first positioning-related signal at a first time, measuring a second timing value for timing-based positioning calculation on the basis of a second positioning-related signal at a second time, deriving movement information indicative of a movement of an apparatus to be positioned during a time interval from the first time to the second time, and signaling the measured first timing value, the measured second timing value and the derived movement information towards a network side for timing-based positioning calculation.

According to an exemplary aspect of the present invention, there is provided an apparatus comprising at least one processor, at least one memory including computer program code, and at least one interface configured for communication with at least another apparatus, the at least one processor, with the at least one memory and the computer program code, being configured to cause the apparatus to perform: receiving a first timing value for timing-based positioning calculation relating to a first time, a second timing relating to a second time, and movement information indicative of a movement of an apparatus to be positioned during a time interval from the first time to the second time, and performing timing-based positioning calculation relating to the apparatus to be positioned on the basis of the received first timing value, second timing value, and movement information.

According to an exemplary aspect of the present invention, there is provided a computer program product comprising computer-executable computer program code which, when the program is run on a computer (e.g. a computer of an apparatus according to any one of the aforementioned apparatus-related exemplary aspects of the present invention), is configured to cause the computer to carry out the method according to any one of the aforementioned method-related exemplary aspects of the present invention.

Such computer program product may comprise or be embodied as a (tangible) computer-readable (storage) medium or the like on which the computer-executable computer program code is stored, and/or the program may be directly loadable into an internal memory of the computer or a processor thereof.

Advantageous further developments or modifications of the aforementioned exemplary aspects of the present invention are set out in the following.

By way of exemplary embodiments of the present invention, there is provided a sensor-assisted improvement of timing-based positioning accuracy (in/for cellular communication systems). More specifically, by way of exemplary embodiments of the present invention, there are provided measures and mechanisms for enabling a sensor-assisted improvement of timing-based positioning accuracy (in/for cellular communication systems).

Thus, enhancements are achieved by methods, apparatuses and computer program products enabling a sensor-assisted improvement of timing-based positioning accuracy (in/for cellular communication systems).

### BRIEF DESCRIPTION OF DRAWINGS

For a more complete understanding of exemplary embodiments of the present invention, reference is now made to the following description taken in connection with the accompanying drawings in which:

FIG. 1 shows a schematic diagram illustrating a system scenario of a timing-based positioning technique, for which exemplary embodiments of the present invention are applicable,

FIG. 2 shows a schematic diagram illustrating a system scenario of a timing-based positioning technique according to exemplary embodiments of the present invention,

FIG. 3 shows schematic diagrams illustrating examples of positioning results for a timing-based positioning technique according to conventional art and a timing-based positioning technique according to exemplary embodiments of the present invention,

FIG. 4 shows a flowchart of an example of a procedure at an apparatus to be positioned according to exemplary embodiments of the present invention,

FIG. 5 shows a flowchart of an example of a procedure for movement information derivation at an apparatus to be positioned according to exemplary embodiments of the present invention,

FIG. 6 shows a flowchart of a first example of a procedure at a network entity according to exemplary embodiments of the present invention,

FIG. 7 shows a flowchart of a second example of a procedure at a network entity according to exemplary embodiments of the present invention,

FIG. 8 shows a flowchart of an example of a procedure for timing-based positioning calculation at a network entity according to exemplary embodiments of the present invention, and

FIG. 9 shows a schematic block diagram illustrating exemplary apparatuses according to exemplary embodiments of the present invention.

### DESCRIPTION OF EXEMPLARY EMBODIMENTS

Exemplary aspects of the present invention will be described herein below. More specifically, exemplary aspects of the present are described hereinafter with reference to particular non-limiting examples and to what are presently considered to be conceivable embodiments of the present invention. A person skilled in the art will appreciate that the invention is by no means limited to these examples, and may be more broadly applied.

It is to be noted that the following description of the present invention and its embodiments mainly refers to specifications being used as non-limiting examples for certain exemplary network configurations and deployments. Namely, the present invention and its embodiments are mainly described in relation to 3GPP specifications being used as non-limiting examples for certain exemplary network configurations and deployments. In particular, a LTE/LTE-Advanced communication system is used as a non-limiting example for the applicability of thus described exemplary embodiments. As such, the description of exemplary embodiments given herein specifically refers to terminology which is directly related thereto. Such terminology is only used in the context of the presented non-limiting examples, and does naturally not limit the invention in any way. Rather, any other network configuration or system deployment, etc. may also be utilized as long as compliant with the features described herein.

Hereinafter, various embodiments and implementations of the present invention and its aspects or embodiments are described using several alternatives. It is generally noted that, according to certain needs and constraints, all of the described alternatives may be provided alone or in any conceivable combination (also including combinations of individual features of the various alternatives).

According to exemplary embodiments of the present invention, in general terms, there are provided mechanisms, measures and means for enabling a sensor-assisted improvement of timing-based positioning accuracy (in/for cellular communication systems).

In the following, exemplary embodiments of the present invention are described with reference to methods, procedures and functions, as well as with reference to structural arrangements and configurations.

More specifically, without restricting generality, the present invention and exemplary embodiments thereof are described with reference to an exemplary case of OTDOA-based positioning in a 3GPP-based LTE communication system. However, the present invention and exemplary embodiments thereof are equally applicable in/for any communication system or technology (including a downlink satellite communication system, a downlink/uplink satellite communication system, a short range communication system, a cellular communication system) utilizing any timing-based positioning or localization technique.

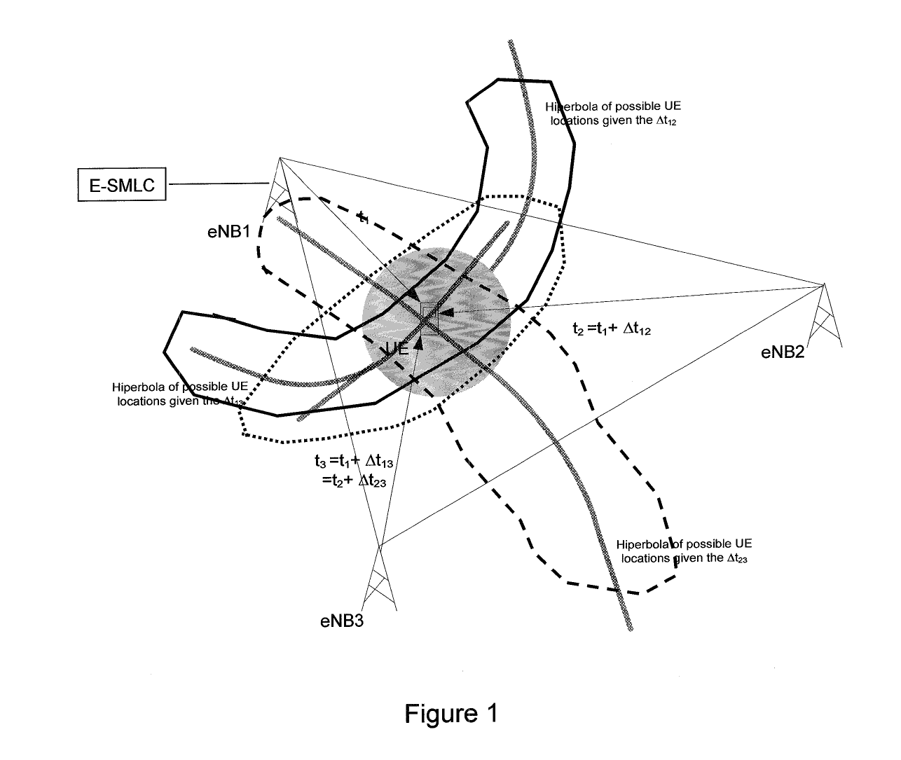

FIG. 1 shows a schematic diagram illustrating a system scenario of a timing-based positioning technique, for which exemplary embodiments of the present invention are applicable.

In the exemplary scenario according to FIG. 1, it is assumed that a terminal UE is to be positioned or localized using the OTDOA-based positioning with respect to three base stations or access nodes eNB1, eNB2, eNB3 serving cells of the underlying cellular communication system. For example, eNB1 may be assumed to be the base station or access node of the cell currently serving the UE, which may be used as a reference for OTDOA measurements. The base stations or access nodes respectively transmit positioning-related signals, such as PRS signals in the DL direction. The timing values t₁, t₂, t₃ respectively relating to the individual base stations or access nodes eNB1, eNB2, eNB3, which are used for OTDOA-based positioning, are measured at the UE on the basis of the received positioning-related signals, and they are shown in their mutual relationship in FIG. 1.

In the OTDOA-based positioning according to FIG. 1, required neighbor cell information are provided from a network entity, such as an E-SMLC, to the UE via the serving base station or access node, such as eNB1 in FIG. 1. The UE measures the OTDOA timing values of each neighboring cell relative to the serving cell based on such neighbor cell information, and provides the measured OTDOA timing values to the server for triangulating the UE position based thereon. The server then calculates the UE position on the basis of the thus provided OTDOA timing values of the neighbor cells and the local knowledge of real cell positions and transmit timings.

In an ideal case, the calculation of the UE position would yield a single point which is a crossing point of three hyperbolas of possible UE positions with respect to any one of the three base stations or access nodes, as depicted by solid lines in FIG. 1. Due to inaccuracies in measurements, variations in radio path conditions or radio propagation paths and the like, in a real/practical case, the calculation of the UE position typically yields an area (probability region) as an intersection of areas (probability regions) around the three hyperbolas of possible UE positions with respect to any one of the three base stations or access nodes, as depicted by forms with solid, dashed an dotted boundary lines in FIG. 1. Accordingly, the practically probable position of the UE corresponds to the grey circle in FIG. 1. In real/practical cases, the resulting area (probability region) for a UE position, i.e. the area of the grey circle in FIG. 1, may be very wide.

In view of the above findings, exemplary embodiments of the present invention teach to take into account additional timing information and/or timing measurements for improving timing-based positioning accuracy in a terminal-assisted manner.

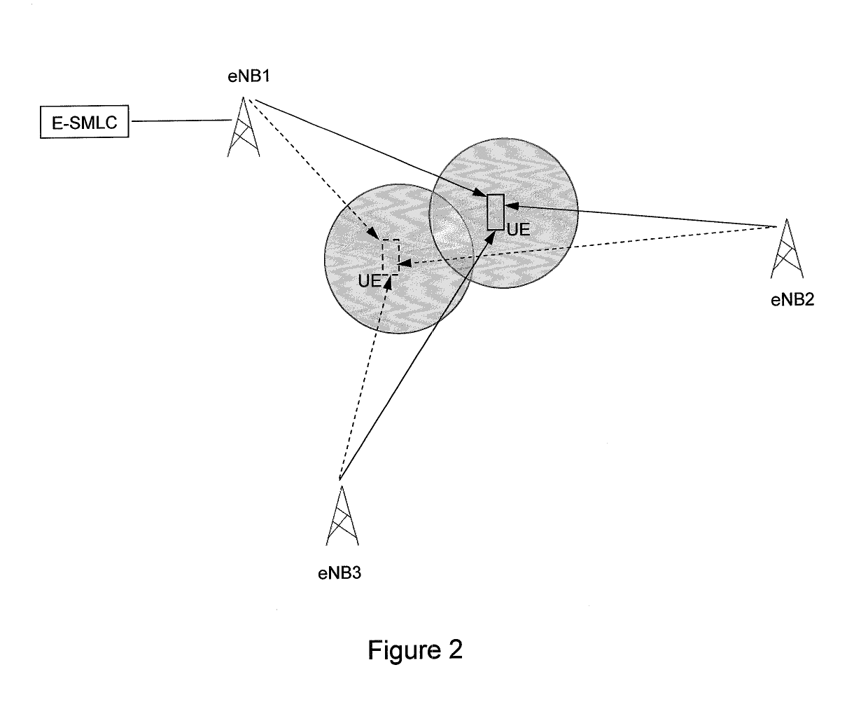

FIG. 2 shows a schematic diagram illustrating a system scenario of a timing-based positioning technique according to exemplary embodiments of the present invention. As compared with FIG. 1, any illustration of hyperbolas, probability regions and the like is omitted for the sake of clarity.

In the exemplary scenario according to FIG. 2, similar to that of FIG. 1 above, it is assumed that a terminal UE is to be positioned or localized using the OTDOA-based positioning. Yet, in the exemplary scenario according to FIG. 2, such OTDOA-based positioning with respect to three base stations or access nodes eNB1, eNB2, eNB3 is performed not only once but twice. At a first time the UE is positioned using three positioning-related signals indicated by dashed arrows, and at a second time (a certain time interval or gap after the first time) the UE is positioned using three positioning-related signals indicated by solid arrows. In FIG. 2, the two potential UE positions are indicated by two grey circles representing a corresponding area (probability region) for a UE position, respectively. As evident from FIG. 2, the two potential UE positions having been subsequently calculated are not necessarily identical, but may differ or even jump randomly, possibly even in a quite large geographical area. The positional difference may result from one or more of an alternating fading environment, alternating propagation conditions, UE movement, alternate concurrent communication resources with positioning-related signals, alternate delays in the receiver, etc.

Accordingly, two potential UE positions are available, while their mutual interrelation and, thus, the appropriate way of utilizing them for (final) UE positioning are typically not evident.

Namely, the deviation between the two potential UE positions could be due to UE movement in the time interval/gap between the two measurements. In such case, it could be appropriate to utilize the later UE position and possibly discard the earlier UE position. Also, the deviation between the two potential UE positions could be due to variations in the (eNB-UE) signal propagation paths (e.g. due to a user's head rotation), variations in environmental (radio) conditions (e.g. due to atmospheric changes), measurement inaccuracies or the like in the time interval/gap between the two measurements, even when the UE has actually not moved in the time interval/gap between the two measurements. In such case, it could be appropriate to commonly utilize both the later UE position and the earlier UE position. Finally, both aforementioned cases could be combined, i.e. the UE may have moved and, at the same time, variations in the (eNB-UE) signal propagation paths, variations in environmental (radio) conditions, measurement inaccuracies or the like may have occurred in the time interval/gap between the two measurements. In such case, it is hardly foreseeable how to judge appropriateness of any one of the later UE position and the earlier UE position.

In view of the above, it is noted that (at least from a practical view) there is always some (possibly quite small) time interval/gap between subsequent measurements (e.g. measurements of concurrent positioning-related signals from different base stations or access nodes). Accordingly, the above-outlined problems arise in all scenarios in which two or more measurements for timing-based positioning are made.

Accordingly, a timing-based positioning technique according to exemplary embodiments of the present invention utilizes (sensor-derived) movement information of the apparatus to be positioned in addition to (timing information and/or timing measurements with respect to) neighboring base stations or access nodes, which represent a serving cell of the apparatus to be positioned and cells adjacent to the serving cell thereof, for positioning the apparatus to be positioned.

Namely, according to exemplary embodiments of the present invention, sensor data of at least one sensor being locally mounted at the apparatus to be positioned may be used in order to incorporate movement information indicative of a movement of the apparatus to be positioned during a time interval from a first time of a first measurement to a second time of a second measurement. By virtue of such movement information, movement (i.e. movement amount, speed, (positive/negative) acceleration, direction or the like) or non-movement of the apparatus to be positioned in the inter-measurement time interval is usable for enabling an appropriate utilization of all potential UE positions (i.e. all available measurements) for improving timing-based positioning accuracy.

According to exemplary embodiments of the present invention, the at least one sensor, from which sensor data may be used, may comprise one or more of an accelerometer sensor, a magnetometer sensor, a gyroscope sensor, or the like. Generally, any sensor, such as any special-purpose sensor, may be used, which may be configured to identify any kinds of movement, including e.g. one or more of amount/distance, speed, acceleration, direction or the like, in one, two or three dimensions (1-D, 2-D, 3-D).

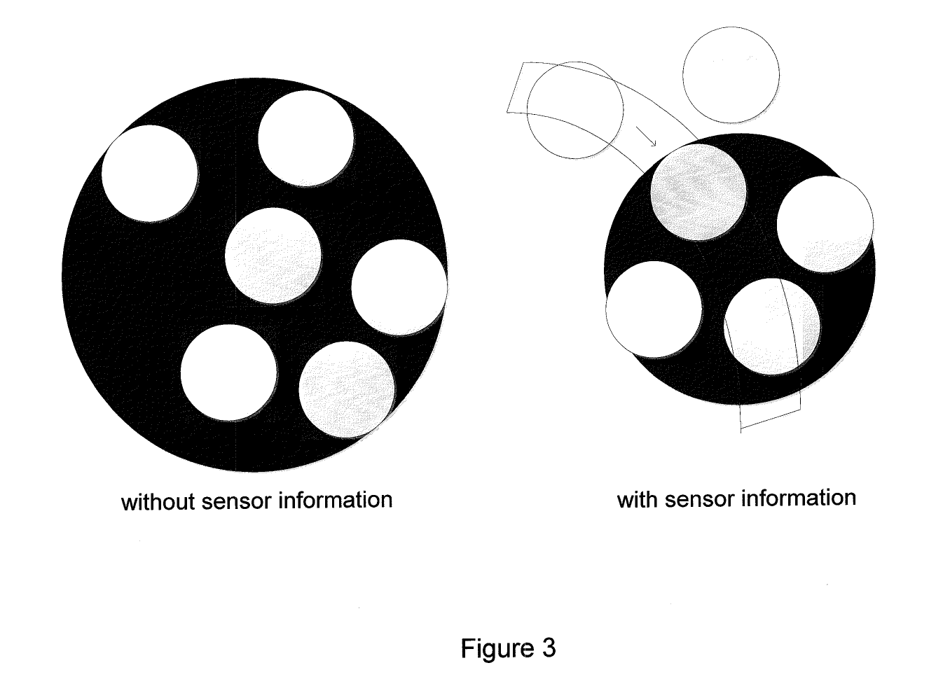

FIG. 3 shows schematic diagrams illustrating examples of positioning results for a timing-based positioning technique according to conventional art and a timing-based positioning technique according to exemplary embodiments of the present invention.

In FIG. 3, the same measurements (or position estimates) are assumed to be present for the positioning according to both timing-based positioning techniques. The underlying position estimates are indicated by six light grey circles representing a corresponding area (probability region) for a UE position, respectively.

On the left side of FIG. 3, a positioning result of the timing-based positioning technique according to conventional art is indicated by a dark grey circle. Namely, in the absence of any additional information regarding the appropriateness/suitability of any one of the six measurement results, the UE position may only be determined to be within a circle encompassing all of the six circles representing the available measurement results.

On the right side of FIG. 3, a trajectory of the apparatus to be positioned is indicated by way of a curvature with an arrow indicating the movement direction. Such trajectory may represent movement information according to exemplary embodiments of the present invention, which may be derived from at least one local UE sensor (such as e.g. an accelerometer sensor and/or a magnetometer and/or a gyroscope sensor and/or any other special purpose sensor). Further, a positioning result of the timing-based positioning technique according to exemplary embodiments of the present invention is indicated by a dark grey circle. Namely, in consideration of the additional movement information according to exemplary embodiments of the present invention, the appropriateness/suitability of any one of the six measurement results may be judged, and only the appropriate/suitable measurement results may be considered for UE positioning. In view of the movement trajectory of the apparatus to be positioned, it may be judged that the upper two measurement results are probably not relevant any more and may thus e.g. be disregarded. Accordingly, the UE position may be determined to be within a circle encompassing only the lower four circles representing the four measurement results with higher probability of appropriateness/suitability in view of the apparatus movement between the individual measurements. As a result, a more accurate positioning result, i.e. a smaller circle of an area (probability region) for the actual position, may be achieved as compared with the convention art.

Generally, according to exemplary embodiments of the present invention, when the UE position is calculated at the server, the calculated UE position may be provided from the server to the UE or to one or more of the UE, the neighboring UEs (i.e. UE1, UE2, UE3) and the surrounding cells (i.e. eNB1, eNB2, eNB3). Such calculated UE position may be provided in accordance with a positioning request, in a predefined time interval, or the like. The serve can proceed its processing depending on a related application, service etc., and/or the UE can continue its processing when one or more sets of positioning results are received from server.

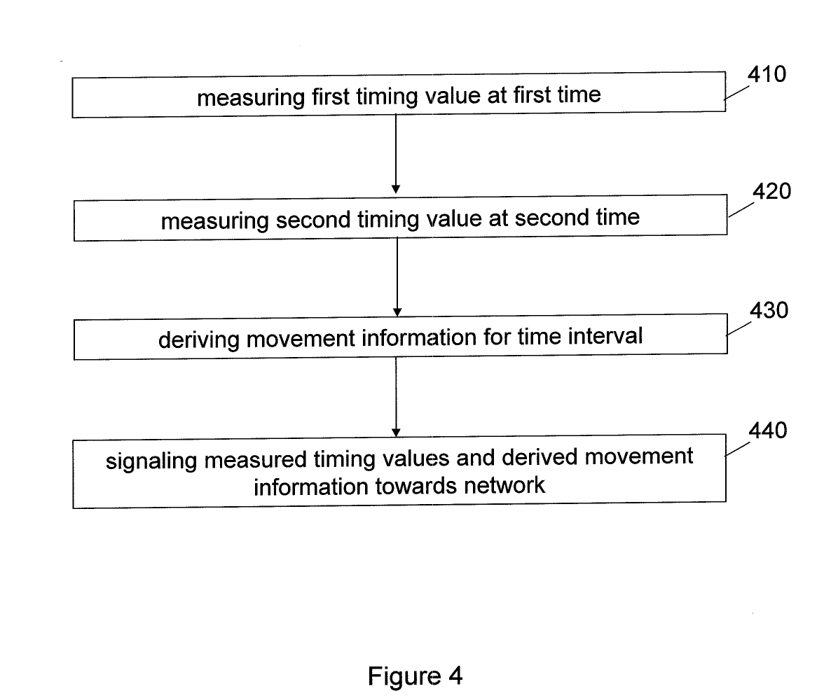

Hereinafter, procedures and functions relating to such timing-based positioning technique according to exemplary embodiments of the present invention are described in more detail with reference to FIGS. 4 to 8.

The methods, procedures and functions described hereinafter mainly relate to an apparatus to be positioned, e.g. a terminal or any other mobile node (e.g. a mobile relay node, car or the like). Such terminal or mobile node may comprise a mobile station (MS) or a user equipment (UE) or a modem (which may be installed as part of a MS or UE, but may be also a separate module, which can be attached to various devices, machines, etc.). Such terminal or modem is configured to be operable in at least one given frequency range/band. Generally, it is to be noted that, when reference is made herein to a terminal, MS or UE, such reference is equally applicable to a modem (which may be installed as part of a MS or UE, but may be also a separate module, which can be attached to various devices, machines, etc.). It is noted that the apparatus to be positioned may, at least in some exemplary embodiments, have multiple receive antennas, a diversity antenna, MIMO antennas, alternate antennas, or the like.

Generally, in the OTDOA-based positioning, a relevant time difference for each neighbor cell or terminal is measured at a certain reference point which, in cellular communication devices/modems, typically is the antenna port or connector or interface of the apparatus to be positioned. In the present specification, for the sake of simplicity, it is assumed that the relevant time difference is measured at the apparatus to be positioned, without considering any processes or the like at or in the apparatus to be positioned.

According to exemplary embodiments of the present invention, the apparatus to be positioned may for example be a TDD-operable terminal which is configured to transmit and receive signals at different times (time periods) at/in the same frequency or frequency band, or a FDD-operable terminal which is configured to transmit and receive signals at different frequencies (frequency bands) at/in the same time (time period).

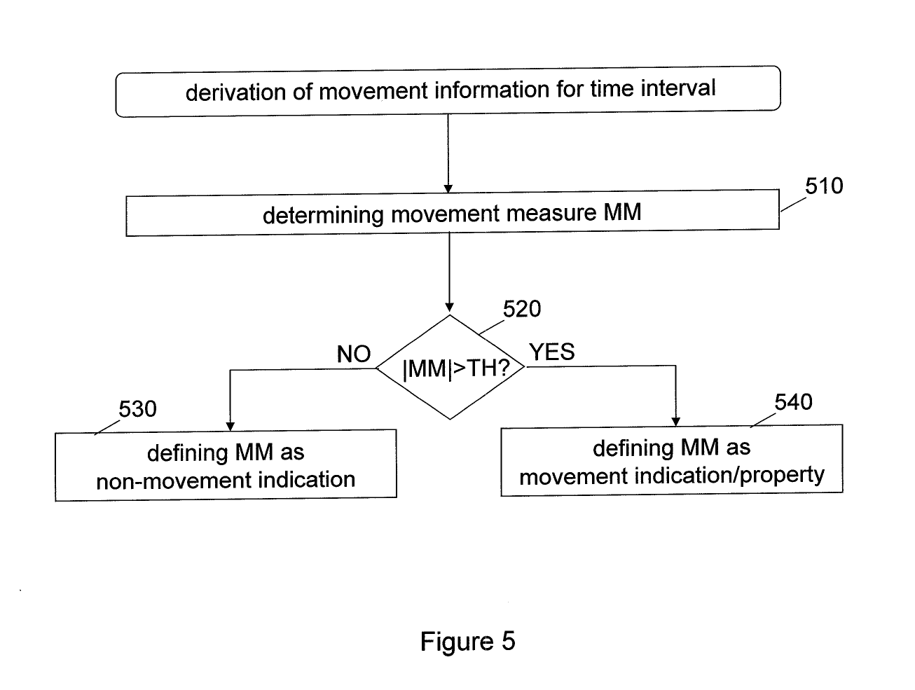

The subsequently described procedures according to FIGS. 4 and 5 may be carried out by or at any apparatus to be positioned, e.g. a terminal such as the UE according to FIG. 2, wherein an apparatus to be positioned suitable for carrying out the thus illustrated procedure may be any (mobile) apparatus to be positioned being capable of receiving signals from surrounding base stations or access nodes and terminals or other mobile nodes. That is to say, such procedure may be carried out by or at a terminal, user equipment, mobile station or modem, wherein any one of these may for example comprise, be comprised in/at or be embodied as/in/at any (short range, cellular, satellite, etc.) wireless communication device such as car communication devices, mobile phones, smart phones, communicators, USB devices, laptops, finger computers, machine-to-machine terminals, device-to-device terminals, routers, terminals of pico/micro/femto cells and the like with wireless communication capability, any kind of vehicles (such as cars, bikes, trains, ships, etc.), and so on.

FIG. 4 shows a flowchart of an example of a procedure at an apparatus to be positioned according to exemplary embodiments of the present invention.

As shown in FIG. 4, a corresponding procedure according to exemplary embodiments of the present invention comprises an operation (410) of measuring a first timing value for timing-based positioning calculation on the basis of a first positioning-related signal at a first time, an operation (420) of measuring a second timing value for timing-based positioning calculation on the basis of a second positioning-related signal at a second time, an operation (430) of deriving movement information indicative of a movement of an apparatus to be positioned during a time interval from the first time to the second time, and an operation (440) of signaling the measured first timing value, the measured second timing value and the derived movement information towards a network side for timing-based positioning calculation.

According to exemplary embodiments of the present invention, the first and second timing value measurements may be made for different times (time periods). In such case, which may be specifically applicable for a TDD operation of the apparatus to be positioned, the first and second positioning-related signals may comprise time division signals, and the first and second timing values may be measured for different time periods of the first and second positioning-related signals. Additionally or alternatively, the first and second timing value measurements may be made for different frequencies (frequency bands). In such case, which may be specifically applicable for a FDD operation of the apparatus to be positioned, the first and second positioning-related signals may comprise frequency division signals, and the first and second timing values may be measured for different frequency bands of the first and second positioning-related signals.

According to exemplary embodiments of the present invention, the positioning-related signals building the bases for measurement of the first and second timing values may originate from the same base station or access node or from different base stations or access nodes. For example, the first and second positioning-related signals may be sent from the same eNB (e.g. eNB1 according to FIG. 2) at different times (i.e. sequentially). Or, the first and second positioning-related signals may be sent from different eNBs (e.g. eNB1 and eNB2 according to FIG. 2) at different times (i.e. sequentially) or at the same time (i.e. concurrently). Even when being sent from different eNBs at the same time, the first and second positioning-related signals typically arrive at the apparatus to be positioned (e.g. the UE according to FIG. 2) at different times, which may be due to the aforementioned radio path-related characteristics such as fading and the like.

According to exemplary embodiments of the present invention, the timing values may comprise OTDOA timing values of one or more cells (such as e.g. eNB2 and eNB3 according to FIG. 2) with respect to a reference cell (such as e.g. eNB1 according to FIG. 2).

According to exemplary embodiments of the present invention, the first and second positioning-related signal may comprise a PRS signal transmitted (in the DL direction) from at least one of a serving cell and a neighboring cell of the serving cell, respectively.

According to exemplary embodiments of the present invention, the movement information may be derived (e.g. combined) from sensor data of at least one sensor mounted at the apparatus to be positioned. Such at least one sensor may for example be one or more of an accelerometer sensor and a magnetometer sensor, and a gyroscope sensor and any other special purpose sensor, but is not limited to such sensors. An accelerometer sensor may particularly provide for information on how much an apparatus has moved (in terms of amount/distance, speed, acceleration), while a magnetometer sensor may particularly provide for information on the direction in which an apparatus has moved. A gyroscope sensor may particularly provide for information on the orientation of an apparatus has moved and/or the direction in which an apparatus has moved. Generally, such sensor may be any sensor capable of providing sensor data indicative of a movement (or non-movement) of the apparatus to be positioned.

According to exemplary embodiments of the present invention, the movement information may be derived by way of a combination of relevant information from multiple (i.e. two or more) sensors or other information sources. For example, speed and acceleration information may be combined.

According to exemplary embodiments of the present invention, the timing values may be measured by using one of an intra-frequency or single-carrier measurement, an inter-frequency or multiple-carrier measurement and a measurement on carrier aggregation components. When the relevant cells respectively operate at/in multiple or mutually different frequencies or frequency bands (e.g. the reference cell and the neighboring cells are operating at the different carriers), corresponding measurements at the apparatus to be positioned, as outlined above, may be accomplished at/in such different frequencies or frequency bands (when the apparatus to be positioned is capable of receiving corresponding positioning-related signals in such different frequencies or frequency bands).

According to exemplary embodiments of the present invention, the timing values and movement information may be signaled towards the network side via the serving cell (i.e. its base station or access node) of the apparatus to be positioned.

FIG. 5 shows a flowchart of an example of a procedure for movement information derivation at an apparatus to be positioned according to exemplary embodiments of the present invention.

The thus illustrated procedure is a non-limiting example for deriving movement information, and may thus be carried out within operation 430, i.e. at the apparatus carrying out the procedure according to FIG. 4. Accordingly, the procedure according to FIG. 5 may be combined with the procedure according to FIG. 4.

As shown in FIG. 5, an operation of deriving movement information for the time interval in question according to exemplary embodiments of the present invention may comprise an operation (510) of determining a movement measure of the movement of the apparatus to be positioned during the time interval, and an operation of defining the movement information depending on characteristics of the determined movement information. For example, as illustrated in FIG. 5, the movement information definition operation may comprise an operation (530) of defining the movement information as a non-movement indication (e.g. a non-movement flag) when an absolute value of the determined movement measure is equal to or smaller than a movement threshold TH (i.e. NO in discrimination 520), and/or an operation (540) of defining the movement information as a movement indication and/or a movement property, including at least one of amount, speed, acceleration and direction of the movement of the apparatus to be positioned, when an absolute value of the determined movement measure is larger than the movement threshold TH (i.e. YES in discrimination 520).

According to exemplary embodiments of the present invention, the movement measure may for example be constituted by a movement vector representing amount (i.e. distance) or speed or (positive/negative) acceleration and direction of the movement in the time interval between the first and second timing value measurements, and the absolute value of the movement measure may be constituted by the length of the vector representing the amount (i.e. distance) or speed or (positive/negative) acceleration of the movement.

According to exemplary embodiments of the present invention, the movement threshold TH may be a fixed (predefined) value or a variable value. Namely, the (application of the) movement threshold TH may involve a hysteresis so that different values may be adopted as the movement threshold TH at different times, e.g. under different conditions. For example, when a previously executed discrimination 520 yielded that the determined movement measure is equal to or smaller than a first movement threshold TH1, a subsequently executed discrimination 520 may use a second movement threshold TH2 which is larger than the first movement threshold TH1. Or, when a previously executed discrimination 520 yielded that the determined movement measure is larger than a third movement threshold TH3, a subsequently executed discrimination 520 may use a second movement threshold TH4 which is smaller than the first movement threshold TH1. In this regard, the first and third movement threshold TH1 and TH3 may be equal, or the third movement threshold TH3 may be larger than the first movement threshold TH1.

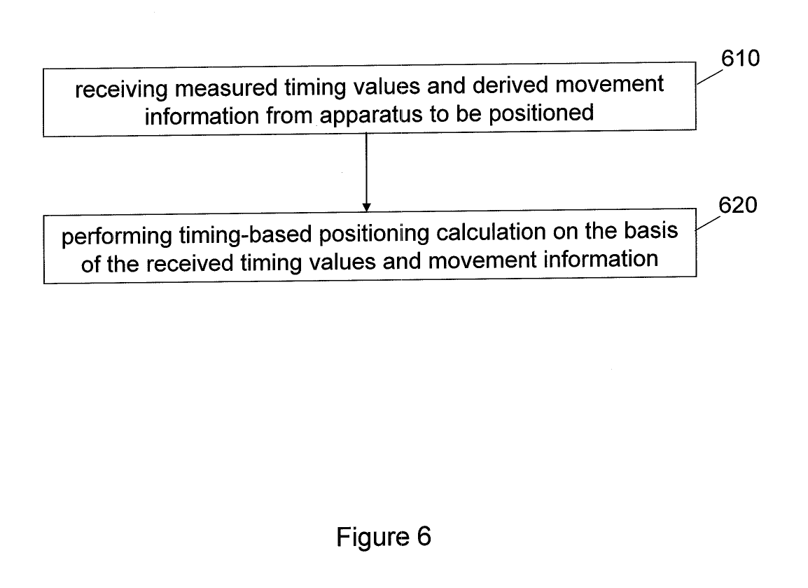

The subsequently described procedures according to FIGS. 6 to 8 may be carried out by or at the network side, i.e. a network entity responsible for performing the timing-based positioning calculation, such as e.g. the E-SMLC according to FIG. 2, where the timing-based positioning calculation may be carried out for any apparatus to be positioned, e.g. a terminal such as the UE according to FIG. 2.

FIG. 6 shows a flowchart of a first example of a procedure at a network entity according to exemplary embodiments of the present invention.

As shown in FIG. 6, a corresponding procedure according to exemplary embodiments of the present invention comprises an operation (610) of receiving a first timing value for timing-based positioning calculation relating to a first time, a second timing relating to a second time, and movement information indicative of a movement of an apparatus to be positioned during a time interval from the first time to the second time, and an operation (620) of performing timing-based positioning calculation relating to the apparatus to be positioned on the basis of the received first timing value, second timing value, and movement information.

According to exemplary embodiments of the present invention, the movement information may be derived (e.g. combined) from sensor data of at least one sensor (e.g. an accelerometer sensor and/or a magnetometer sensor and/or a gyroscope sensor and/or any other special purpose sensor) mounted at the apparatus to be positioned. Accordingly, information from the accelerometer sensor and/or the magnetometer sensor and/or the gyroscope sensor and/or any other special purpose sensor from the apparatus to be positioned may exemplarily be used in timing-based positioning calculation to improve accuracy thereof based on knowledge on how (i.e. how much and/or in which direction) the apparatus position has changed during/between the timing value measurement times.

According to exemplary embodiments of the present invention, the timing-based positioning calculation in operation 620 may be performed using known positions of cells surrounding the apparatus to be positioned, with which the received timing values are in relationship. That is to say, as in the above-outlined concept of OTDOA-based positioning, transmit timings and geographical locations of the cells being involved in the positioning process may be incorporated together with the respective timing values, i.e. timing difference values.

According to exemplary embodiments of the present invention, the timing values and movement information may be received from the apparatus to be positioned via its serving cell (i.e. its base station or access node).

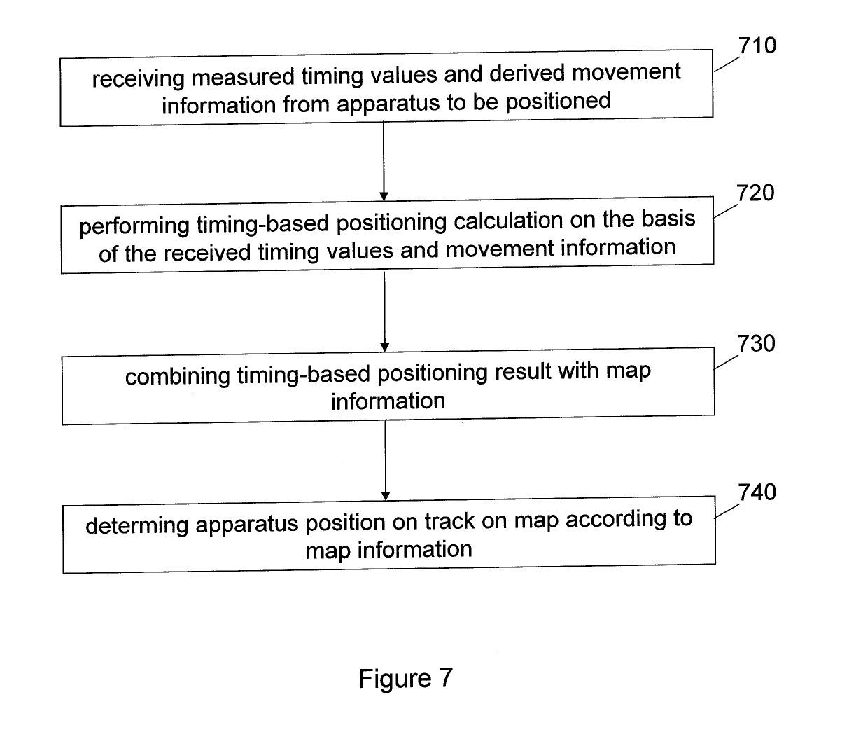

FIG. 7 shows a flowchart of a second example of a procedure at a network entity according to exemplary embodiments of the present invention.

As shown in FIG. 7, a corresponding procedure according to exemplary embodiments of the present invention comprises operations 710 and 720 which functionally correspond to the operations 610 and 620 according to FIG. 6. Further, on the basis of the thus performed timing-based positioning calculation, a corresponding procedure according to exemplary embodiments of the present invention comprises an operation (730) of combining a timing-based positioning result (i.e. a result of operation 720) with (locally available) map information, and an operation (740) of determining the position of the apparatus to be positioned on the basis of the timing-based positioning result such that it is located on a track on a map according to the map information at a track position with highest probability.

Such map information may for example comprise any one or more of street map information, railway map information, waterway map information, hiking map information, bikeway map information, building floor plan information, and the like.

According to exemplary embodiments of the present invention, the calculated apparatus position may thus be further refined in consideration of a real environment being represented by map information. Namely, it is utilized that an apparatus to be positioned is more likely to be located on a certain track than aside thereof. Depending on the type of the apparatus to be positioned or a mobile unit on which such apparatus to be positioned is mounted (e.g. a vehicle, train, subway, bike, ship, etc.), a certain type of track may be relevant. For example, a relevant track may be any kind of street for car-related positioning, any kind of railway track for train-related positioning, any kind of subway track for subway-related positioning, any kind of bikeway for bike-related positioning, any kind of waterway for ship-related-positioning, and so on.

According to exemplary embodiments of the present invention, an apparatus position may be determined based on such combination in that a track position nearest to the position of the timing-based positioning result is taken as the most probably track position, a track position (of a track intersecting an area of the timing-based positioning result) at a point of highest probability of the timing-based positioning result area is taken as the most probably track position, or the like. In this regard, the movement information may also be taken into consideration for determining a most appropriate track, and the like.

A combination of a timing-based positioning result with map information may be particularly useful for a rapidly moving apparatus to be positioned (since, as a general rule, positioning accuracy may decrease with an increase of movement speed), but could be generally applied to any apparatus to be positioned irrespective of the movement speed thereof.

According to exemplary embodiments of the present invention, the combination of a timing-based positioning result with map information may be performed depending on an absolute value of a movement measure of the movement information. For example, such combination may be performed only when a movement speed representing an absolute value of a movement measure is equal to or larger than a threshold speed which may be a fixed (predetermined) value or a variable value (realizing hysteresis), as outlined above in connection with discrimination 520 according to FIG. 5. In such case, a similar discrimination as that of 520 according to FIG. 5 may be made.

It is to be noted that, according to exemplary embodiments of the present invention, the functionality described above in connection with operations 730 and 740 could also (i.e. additionally or alternatively) be accomplished at the apparatus to be positioned. In this regard, the timing-based positioning result (i.e. the result of operation 720) is reported from the network entity to the apparatus to be positioned (as indicated above), and the apparatus to be positioned, upon receiving the reported-based positioning result, combines the same with locally available map information, and then determines its position on the basis of the timing-based positioning result such that it is located on a track on a map according to the map information at a track position with highest probability. Such operations at the apparatus to be positioned could follow subsequent to operation 440 according to FIG. 4 above.

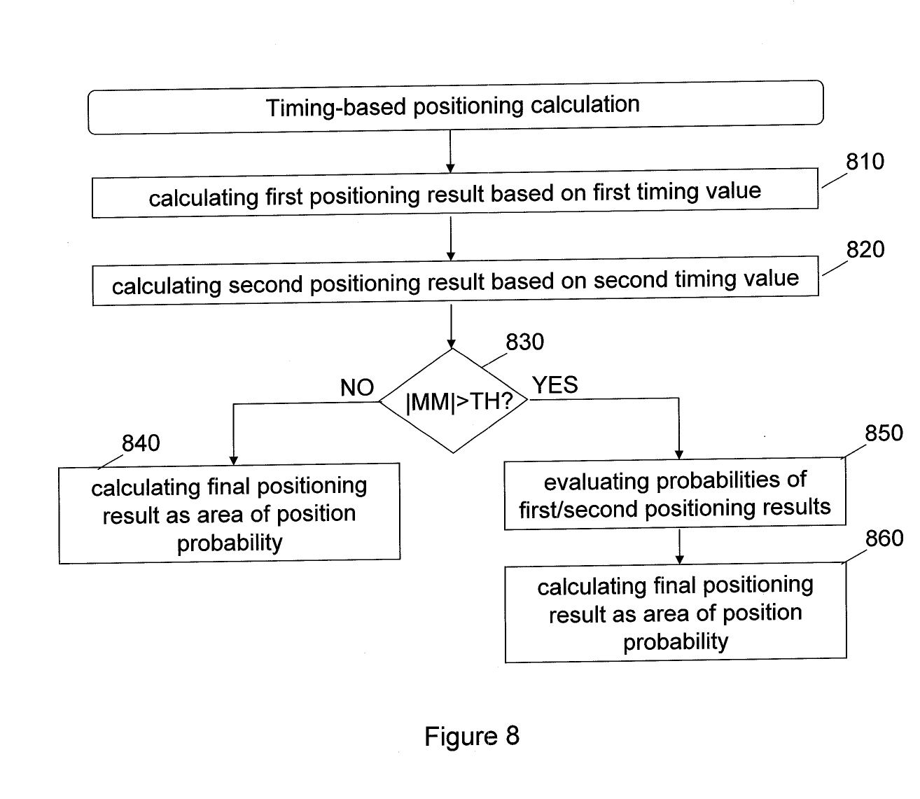

FIG. 8 shows a flowchart of an example of a procedure for timing-based positioning calculation at a network entity according to exemplary embodiments of the present invention.

The thus illustrated procedure is a non-limiting example for performing a timing-based positioning calculation, and may thus be carried out within any one of operations 620 and 720, i.e. at the apparatus carrying out the procedure according to any one of FIGS. 6 and 7. Accordingly, the procedure according to FIG. 8 may be combined with the procedure according to any one of FIGS. 6 and 7.

As shown in FIG. 8, a corresponding procedure according to exemplary embodiments of the present invention comprises an operation (810) of calculating a first timing-based positioning result on the basis of the first timing value, an operation (820) of calculating a second timing-based positioning result on the basis of the second timing value, and an operation of calculating a final timing-based positioning result for the apparatus to be positioned depending on characteristics of the received movement information. For example, as illustrated in FIG. 8, when an absolute value of the received movement measure is equal to or smaller than a movement threshold TH (i.e. NO in discrimination 830), the calculation of the final timing-based positioning result may comprise an operation (840) of calculating a final timing-based positioning result for the apparatus to be positioned as an area of probability of the position thereof on the basis of the calculated first and second timing-based positioning results. For example, as illustrated in FIG. 8, when an absolute value of the received movement measure is larger than a movement threshold TH (i.e. YES in discrimination 830), the calculation of the final timing-based positioning result may comprise an operation (850) of evaluating probabilities of the first and second timing-based positioning results in accordance with a movement property, including the at least one of amount, speed, acceleration and direction of the movement of the apparatus to be positioned, and an operation (860) of calculating a final timing-based positioning result for the apparatus to be positioned as an area of probability of the position thereof on the basis of the evaluated probabilities of the calculated first and second timing-based positioning results.

According to exemplary embodiments of the present invention, the movement threshold TH may be a fixed (predefined) value or a variable value (realizing hysteresis). In this regard, reference is made to the foregoing description in connection with discrimination 520 according to FIG. 5.

According to exemplary embodiments of the present invention, when the apparatus to be positioned is stationary or nearly stationary (i.e. NO in discrimination 830), a most probable position may be where most calculation hits of the first and second positioning results are located. Referring to the exemplary illustration of FIG. 2, assuming that the UE has not actually moved between the two measurements, the most probable position would be inside the intersection area of the two circles.

According to exemplary embodiments of the present invention, when the apparatus to be positioned is not stationary or nearly stationary (i.e. YES in discrimination 830), i.e. when the apparatus has (substantially) moved in inter-measurement time interval, a most probable position may be that which best fits to the movement of the apparatus inter-measurement time interval. Referring to the exemplary illustration of FIG. 3, the most probable position would be inside the dark grey circle encompassing the lower four light grey circles representing respective positioning results.

According to exemplary embodiments of the present invention, later/newer measurements and/or positioning results can be weighted with a higher weight or probability than former/older measurements and/or positioning results. Such weighting may be based on the movement information, e.g. an absolute value of a movement measure of the movement information (which may represent movement speed or distance or acceleration or direction or the like). For example, former/older measurements and/or positioning results may be even discarded for the final positioning calculation. Referring to the procedure according to FIG. 8, such weighting may be accomplished in the context of the evaluation operation 850. Thereby, the positioning accuracy may be even further improved.

According to exemplary embodiments of the present invention, measurements and/or positioning results can be combined with any special purpose information. Such special purpose information may comprise e.g. the type of the apparatus to be positioned (as indicated herein), any service-related information (referring to the availability/location of services such as e.g. gasoline stations, hospitals, banks, libraries, food stores, restaurants, etc.), information relating to emergency and/or public safety facilities, any infrastructure-related information (such as e.g. taxi stands, airports, public transport facilities such as bus/subway/train stations, etc.). Such special purpose information may be available e.g. from special purpose servers (which may e.g. be provided/operated by a service provider, a communication network operator, a transport network operator, a specialized information provider, a map provider, etc.) or the like. Thereby, the value or applicability of the positioning result may be even further enhanced.

According to exemplary embodiments of the present invention, the aforementioned map information and the aforementioned special purpose information may also be integrated/combined, and measurements and/or positioning results can be combined with such integrated/combined map/special-purpose information.

The technical effects of exemplary embodiments of the present invention, particularly an improved positioning accuracy, may for example be specifically useful in emergency or rescue cases and/or public safety use cases. Namely, in such emergency or rescue cases and/or public safety use cases, lives could be saved and damages/injuries could be reduced and human safety could be ensured, as exemplary embodiments of the present invention enable a quick focusing on an accurate position of a terminal (and its user) in question.

According to exemplary embodiments of the present invention, although this is not illustrated in the accompanying drawings, the network entity responsible for performing the timing-based positioning calculation, i.e. the apparatus performing any one of the procedures according to FIGS. 6 to 8, may also perform an operation of forwarding the received movement information towards another network entity such as an emergency-related network entity and/or a public safety-related network entity (e.g. an emergency or rescue center, a police department, a fire department, a traffic, transport, objects, animals control/surveillance center, or the like). While not being restricted thereto, such forwarding may be specifically applicable for the forwarding of a non-/movement indication (which could e.g. be implemented by a flag, such as a TRUE/FALSE flag or a 0/1 flag) for all apparatuses being positioned within a certain geographical area in which an emergency or rescue case and/or a public safety case is currently prevailing.

Namely, by using the non-/movement indication, randomly jumping apparatus positions (varying e.g. due to signals reflections, fading, or the like) could be recognized as relating to actually stationary or nearly stationary apparatuses, e.g. a user is sitting/standing at one place. Accordingly, it could be recognized that there is possibly still a person (i.e. the apparatus user) within an emergency or rescue scenario and/or a public safety scenario, who does not move (although he/she might appear to move due to jumping positions). This may be important knowledge for an emergency or rescue or public safety team to know that there seems to be a helpless (possibly trapped or unconscious) person within the emergency or rescue or public safety scenario. This is the case, as e.g. in a fire case not all persons may be able to make a call, but with corresponding information from the OTDOA information server a decision may be made that some UEs are at an area of fire/gas, etc. Additionally, the OTDOA information server could provide information on the number of apparatuses positioned within the emergency or rescue or public safety scenario, particularly the number of non-moving apparatuses (for which a non-/movement indication is received) and/or the number of moving apparatuses (for which no non-/movement indication is received).

Generally, the above-described procedures and functions may be implemented by respective functional elements, processors, or the like, as described below.

While in the foregoing exemplary embodiments of the present invention are described mainly with reference to methods, procedures and functions, corresponding exemplary embodiments of the present invention also cover respective apparatuses, network nodes and systems, including both software and/or hardware thereof.

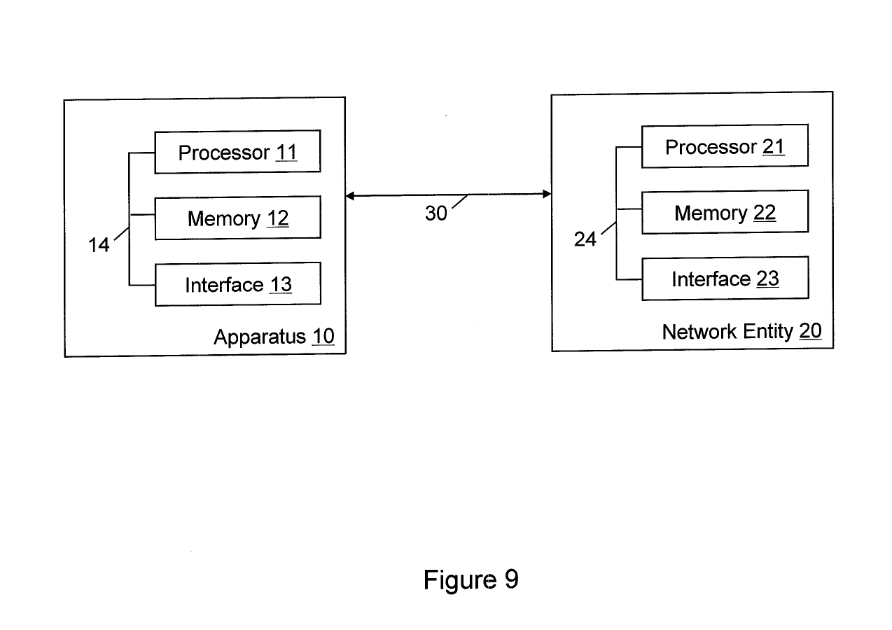

Respective exemplary embodiments of the present invention are described below referring to FIG. 9, while for the sake of brevity reference is made to the detailed description with regard to FIGS. 1 to 8.

In FIG. 9 below, which is noted to represent a simplified block diagram, the solid line blocks are basically configured to perform respective operations as described above. The entirety of solid line blocks are basically configured to perform the methods and operations as described above, respectively. With respect to FIG. 9, it is to be noted that the individual blocks are meant to illustrate respective functional blocks implementing a respective function, process or procedure, respectively. Such functional blocks are implementation-independent, i.e. may be implemented by means of any kind of hardware or software, respectively. The arrows and lines interconnecting individual blocks are meant to illustrate an operational coupling there-between, which may be a physical and/or logical coupling, which on the one hand is implementation-independent (e.g. wired or wireless) and on the other hand may also comprise an arbitrary number of intermediary functional entities not shown. The direction of arrow is meant to illustrate the direction in which certain operations are performed and/or the direction in which certain data is transferred.

Further, in FIG. 9, only those functional blocks are illustrated, which relate to any one of the above-described methods, procedures and functions. A skilled person will acknowledge the presence of any other conventional functional blocks required for an operation of respective structural arrangements, such as e.g. a power supply, a central processing unit, respective memories or the like. Among others, memories are provided for storing programs or program instructions for controlling the individual functional entities to operate as described herein.

FIG. 9 shows a schematic block diagram illustrating exemplary apparatuses according to exemplary embodiments of the present invention.

In view of the above, the thus described apparatuses 10 and 20 are suitable for use in practicing the exemplary embodiments of the present invention, as described herein. The thus described apparatus 10 may represent an (part of an) apparatus to be positioned, such as a terminal or other mobile node, e.g. a mobile station MS or user equipment UE or a modem (which may be installed as part of a MS or UE, but may be also a separate module, which can be attached to various devices, as described above), and may be configured to perform a procedure and/or functionality as described in conjunction with any one of FIGS. 2 to 5. The thus described apparatus 20 may represent a (part of a) network entity responsible for timing-based positioning calculation, such as an E-SMLC or a corresponding network entity, and may be configured to perform a procedure and/or functionality as described in conjunction with any one of FIGS. 2, 3, and 6 to 8.

An apparatus or terminal to be positioned according to exemplary embodiments of the present invention may for example comprise any (short range, cellular, satellite, etc.) wireless communication device such as car communication devices, mobile phones, smart phones, communicators, USB devices, laptops, finger computers, machine-to-machine terminals, device-to-device terminals, routers, terminals of pico/micro/femto cells and the like with wireless communication capability, any kind of vehicles (such as cars, bikes, trains, ships, etc.), and so on.

According to exemplary embodiments of the present invention, the apparatus 10 may represent a terminal, user equipment, mobile station or modem, wherein any one of these may for example comprise, be comprised in/at or be embodied as/in/at any one of the aforementioned types of apparatus or terminal to be positioned according to exemplary embodiments of the present invention.

As indicated in FIG. 9, according to exemplary embodiments of the present invention, each of the apparatuses comprises a processor 11/22, a memory 12/22 and an interface 13/23, which are connected by a bus 14/24 or the like, and the apparatuses may be connected via a link 30. The link 30 may be a physical and/or logical coupling, which on the one hand is implementation-independent (e.g. wired or wireless) and on the other hand may also comprise an arbitrary number of intermediary functional entities not shown in FIG. 9 (such as a base station or access node, e.g. that of a serving cell of the apparatus to be positioned, such as eNB1 illustrated in FIG. 2). The direction of arrow is meant to illustrate the direction in which certain operations are performed and/or the direction in which certain data is transferred.

The processor 11/21 and/or the interface 13/23 may be facilitated for communication over a (hardwire or wireless) link, respectively. The interface 13/23 may comprise a suitable receiver or a suitable transmitter-receiver combination or transceiver, which is coupled to one or more antennas or communication means for (hardwire or wireless) communications with the linked or connected device(s), respectively. The interface 13/23 is generally configured to communicate with another apparatus, i.e. the interface thereof.

The memory 12/22 may store respective programs assumed to include program instructions or computer program code that, when executed by the respective processor, enables the respective electronic device or apparatus to operate in accordance with the exemplary embodiments of the present invention. For example, the memory 12 of the apparatus 10 may store any measurement/derivation results, map information or the like, and the memory 23 of the network entity 20 may store the any received information, map information, available positions of cells or the like.

In general terms, the respective devices/apparatuses (and/or parts thereof) may represent means for performing respective operations and/or exhibiting respective functionalities, and/or the respective devices (and/or parts thereof) may have functions for performing respective operations and/or exhibiting respective functionalities.

When in the subsequent description it is stated that the processor (or some other means) is configured to perform some function, this is to be construed to be equivalent to a description stating that at least one processor, potentially in cooperation with computer program code stored in the memory of the respective apparatus, is configured to cause the apparatus to perform at least the thus mentioned function. Also, such function is to be construed to be equivalently implementable by specifically configured means for performing the respective function (i.e. the expression “processor configured to [cause the apparatus to] perform xxx-ing” is construed to be equivalent to an expression such as “means for xxx-ing”).

According to exemplary embodiments of the present invention, an apparatus representing the apparatus 10 comprises at least one processor 11, at least one memory 12 including computer program code, and at least one interface 13 configured for communication with at least another apparatus. Although not shown, an apparatus representing the apparatus 10 according to exemplary embodiments of the present invention also comprises at least one sensor as described above. The processor (i.e. the at least one processor 11, with the at least one memory 12 and the computer program code) is configured to perform measuring a first timing value for timing-based positioning calculation on the basis of a first positioning-related signal at a first time, measuring a second timing value for timing-based positioning calculation on the basis of a second positioning-related signal at a second time, deriving movement information indicative of a movement of an apparatus to be positioned during a time interval from the first time to the second time, and signaling the measured first timing value, the measured second timing value and the derived movement information towards a network side for timing-based positioning calculation.

According to exemplary embodiments of the present invention, the processor (i.e. the at least one processor 11, with the at least one memory 12 and the computer program code) may be configured to perform determining a movement measure of the movement of the apparatus to be positioned during the time interval, and defining the movement information as a non-movement indication when an absolute value of the determined movement measure is equal to or smaller than a movement threshold, or defining the movement information as a movement indication and/or a movement property, including at least one of amount, speed, acceleration and direction of the movement of the apparatus to be positioned, when an absolute value of the determined movement measure is larger than the movement threshold.

According to exemplary embodiments of the present invention, an apparatus representing the network entity 20 comprises at least one processor 20, at least one memory 22 including computer program code, and at least one interface 23 configured for communication with at least another apparatus. The processor (i.e. the at least one processor 21, with the at least one memory 22 and the computer program code) is configured to perform receiving a first timing value for timing-based positioning calculation relating to a first time, a second timing relating to a second time, and movement information indicative of a movement of an apparatus to be positioned during a time interval from the first time to the second time, and performing timing-based positioning calculation relating to the apparatus to be positioned on the basis of the received first timing value, second timing value, and movement information.

According to exemplary embodiments of the present invention, the processor (i.e. the at least one processor 21, with the at least one memory 22 and the computer program code) may be configured to perform:

when the movement information comprises a non-movement indication, the at least one processor, calculating a first timing-based positioning result on the basis of the first timing value, calculating a second timing-based positioning result on the basis of the second timing value, and calculating a final timing-based positioning result for the apparatus to be positioned as an area of probability of the position thereof on the basis of the calculated first and second timing-based positioning results, and/or

when the movement information comprises a movement property, including at least one of amount, speed, acceleration and direction of the movement of the apparatus to be positioned, calculating a first timing-based positioning result on the basis of the first timing value, calculating a second timing-based positioning result on the basis of the second timing value, evaluating probabilities of the first and second timing-based positioning results in accordance with the movement property, and calculating a final timing-based positioning result for the apparatus to be positioned as an area of probability of the position thereof on the basis of the evaluated probabilities of the calculated first and second timing-based positioning results, and/or

weighting the probability of a newer positioning result with a higher weight than the probability of an older positioning result, and/or

combining a timing-based positioning result with map information, and determining the position of the apparatus to be positioned on the basis of the timing-based positioning result such that it is located on a track on a map according to the map information at a track position with highest probability, and/or

forwarding the received movement information to at least one of an emergency-related network entity and a public safety-related network entity.

For further details of specifics regarding functionalities according to exemplary embodiments of the present invention, reference is made to the foregoing description in conjunction with FIGS. 2 to 8.

According to exemplarily embodiments of the present invention, a system may comprise any conceivable combination of the thus depicted devices/apparatuses and other network elements, which are configured to cooperate as described above.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any procedural step or functionality is suitable to be implemented as software or by hardware without changing the idea of the present invention. Such software may be software code independent and can be specified using any known or future developed programming language, such as e.g. Java, C++, C, and Assembler, as long as the functionality defined by the method steps is preserved. Such hardware may be hardware type independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components. A device/apparatus may be represented by a semiconductor chip, a chipset, system in package (SIP), or a (hardware) module comprising such chip or chipset; this, however, does not exclude the possibility that a functionality of a device/apparatus or module, instead of being hardware implemented, be implemented as software in a (software) module such as a computer program or a computer program product comprising executable software code portions for execution/being run on a processor. A device may be regarded as a device/apparatus or as an assembly of more than one device/apparatus, whether functionally in cooperation with each other or functionally independently of each other but in a same device housing, for example.

Apparatuses and/or means or parts thereof can be implemented as individual devices, but this does not exclude that they may be implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present invention also covers any conceivable combination of method steps and operations described above, and any conceivable combination of nodes, apparatuses, modules or elements described above, as long as the above-described concepts of methodology and structural arrangement are applicable.

In view of the above, the present invention and/or exemplary embodiments thereof provide measures for enabling a sensor-assisted improvement of timing-based positioning accuracy. Such measures may exemplarily comprise measuring a first timing value for timing-based positioning calculation on the basis of a first positioning-related signal at a first time, measuring a second timing value for timing-based positioning calculation on the basis of a second positioning-related signal at a second time, deriving movement information indicative of a movement of an apparatus to be positioned during a time interval from the first time to the second time, and utilizing the measured first timing value, the measured second timing value and the derived movement information for timing-based positioning calculation relating to the apparatus to be positioned at a network side.

Even though the present invention and/or exemplary embodiments are described above with reference to the examples according to the accompanying drawings, it is to be understood that they are not restricted thereto. Rather, it is apparent to those skilled in the art that the present invention can be modified in many ways without departing from the scope of the inventive idea as disclosed herein.

### LIST OF ACRONYMS AND ABBREVIATIONS

3GPP Third Generation Partnership Project
DL Downlink
eNB evolved Node B (E-UTRAN base station)
E-SMLC Evolved Serving Mobile Location Center
FDD Frequency Division Duplex
GPS Global Positioning System
LCS Location Service/Location-based Service
LTE Long Term Evolution
LTE-A Long Term Evolution Advanced
MIMO Multiple-Input Multiple-Output
OTDOA Observed Time Difference of Arrival
PRS Positioning Reference Signal
TDD Time Division Duplex
UE User Equipment
UL Uplink

1. A method for use in observed time difference of arrival timing-based determination of position of a user equipment of a cellular communication system, said method comprising:
measuring a first timing value for timing-based positioning calculation on the basis of a first positioning-related signal at a first time;
measuring a second timing value for timing-based positioning calculation on the basis of a second positioning-related signal at a second time;
deriving movement information indicative of a movement of the user equipment to be positioned during a time interval from the first time to the second time; and
signaling the measured first timing value, the measured second timing value, and the derived movement information towards a base station or access node of said system for use in observed time difference of arrival timing-based positioning calculation,
wherein deriving the movement information comprises:
determining a movement measure of the movement of the user equipment to be positioned during the time interval; and
defining the movement information as a non-movement indication when an absolute value of the determined movement measure is equal to or smaller than a movement threshold, and defining the movement information as a movement indication and/or a move milt property, including at least two of amount, speed, acceleration and direction of the movement of the user equipment to be positioned, when an absolute value of the determined movement measure is larger than the movement threshold.

2. (canceled)

3. The method according to claim 1, wherein:
the movement information is derived from sensor data of at least one sensor mounted at the user equipment to be positioned, and
the at least one sensor comprises at least one of an accelerometer sensor, a gyroscope sensor and a magnetometer sensor.

4. The method according to claim 1, wherein:
the first and second positioning-related signals comprise time division signals, and the first and second timing values are measured for different time periods of the first and second positioning-related signals, and/or
the first and second positioning-related signals comprise frequency division signals, and the first and second timing values are measured for different frequency bands of the first and second positioning-related signals.

5. The method according to claim 1, wherein:
the first and second positioning-related signals comprise positioning reference signals from one of a serving cell of the user equipment to be positioned and a neighboring cell of the serving cell, respectively, and/or
the first timing value and/or the second timing value is measured by using one of an intra-frequency or single-carrier measurement, an inter-frequency or multiple-carrier measurement and a measurement on carrier aggregation component, and/or
the method is operable at or by a user equipment, mobile station or modem, and/or
the method is operable at or by a user equipment, mobile station or modem operable in time division duplex or frequency division duplex, and/or
the method is operable in at least one of a LTE and a LTE-A cellular system.

6. A method for use in observed time difference of arrival timing-based determination of position of a user equipment of a cellular communication system, said method comprising, at a base station or access node of said system:
receiving, from said user equipment, a first timing value for timing-based positioning calculation relating to a first time, a second timing relating to a second time, and movement information indicative of a movement of user equipment to be positioned during a time interval from the first time to the second time; and
performing observed time difference of arrival timing-based positioning calculation relating to the user equipment to be positioned on the basis of the received first timing value, second timing value, and movement information,
wherein the movement information comprises a movement properly; including at least two of amount, speed, acceleration and direction of the movement of the user equipment to be positioned, and performing the timing-based positioning calculation comprises;
calculating a first timing-based positioning result on the basis of the first timing value; calculating a second timing-based positioning result on the basis of the second timing value;
evaluating probabilities of the first and second timing-based positioning results in accordance with the movement property; and
calculating a final timing-based positioning result for the user equipment to be positioned as an area of probability of the position thereof on the basis of the evaluated probabilities of the calculated first and second timing-based positioning results.

7. (canceled)

8. (canceled)

9. The method according to claim 6, wherein evaluating the probabilities of the first and second timing-based positioning results comprises:
weighting the probability of a newer positioning result with a higher weight than the probability of an older positioning result.

10. The method according to claim 6, wherein performing timing-based positioning calculation comprises:
combining a timing-based positioning result with map information, and
determining the position of the user equipment to be positioned on the basis of the timing-based positioning result such that it is located on a track on a map according to the map information at a track position with highest probability.

11. The method according to claim 6, wherein:
the method further comprises forwarding the received movement information to at least one of an emergency-related network entity and a public safety-related network entity, and/or
the method is operable at or by a network entity responsible for positioning calculation, and/or
the method is operable at or by a serving mobile location center, and/or
the method is operable in at least one of a LTE and a LTE-A cellular system.

12. An apparatus for use in observed time difference of arrival timing-based determination of position of a user equipment of a cellular communication system, said apparatus comprising a processing system configured to cause the apparatus to, at said user equipment:
measure a first timing value for timing-based positioning calculation on the basis of a first positioning-related signal at a first time;
measure a second timing value for timing-based positioning calculation on the basis of a second positioning-related signal at a second time;
derive movement information indicative of a movement of the user equipment to be positioned during a time interval from the first time to the second time; and
signal the measured first timing value, the measured second timing value and the derived movement information towards a base station or access node of said system for use in observed time difference of arrival timing-based positioning calculation for timing-based positioning calculation, wherein the processing system is configured to cause the apparatus to, at the user equipment:
determine a movement measure of the movement of the user equipment to be positioned during the time interval;
define the movement information as a non-movement indication when an absolute value of the determined movement measure is equal to or smaller than a movement threshold; and
define the movement information as a movement indication and/or a movement property, including at least two of amount, speed, acceleration and direction of the movement of the user equipment to be positioned, when an absolute value of the determined movement measure is larger than the movement threshold.

13. (canceled)

14. The apparatus according to claim 12, wherein:
the processing system is configured to cause the apparatus to derive the movement information from sensor data of at least one sensor mounted at the user equipment to be positioned, and
wherein the at least one sensor comprises at least one of an accelerometer sensor, a gyroscope sensor and a magnetometer sensor.

15. The apparatus according to claim 12, wherein
the first and second positioning-related signals comprise time division signals, and the processing system is configured to cause the apparatus to measure the first and second timing values for different time periods of the first and second positioning-related signals, and/or
the first and second positioning-related signals comprise frequency division signals, and the processing system is configured to cause the apparatus to measure the first and second timing values for different frequency hands of the first and second positioning-related signals.

16. The apparatus according to claim 12, wherein:
the first and second positioning-related signals comprise positioning reference signals from one of a serving cell of the user equipment to be positioned and a neighboring cell of the serving cell, respectively, and/or
the processing system is configured to cause the apparatus to measure the first timing value and/or the second timing value by using one of an intra-frequency or single-carrier measurement, an inter-frequency or multiple-carrier measurement and a measurement on carrier aggregation components, and/or
the apparatus is operable as or at a user equipment, mobile station or modem, and/or
the apparatus is operable as or at a user equipment, mobile station or modem operable in time division duplex or frequency division duplex, and/or
the apparatus is operable in at least one of a LIT and a LTE-A cellular system.

17. An apparatus for use in observed time difference of arrival timing-based determination of position of a user equipment of a cellular communication system, said apparatus comprising a processing system configured to cause the apparatus to at a base station or access node of said system:
receive, from said user equipment, a first timing value for timing-based positioning calculation relating to a first time, a second timing relating to a second time, and movement information indicative of a movement of the user equipment to be positioned during a time interval from the first time to the second time; and
perform observed time difference of arrival timing-based positioning calculation relating to the user equipment to be positioned on the basis of the received first timing value, second timing value, and movement information, wherein the movement information comprises a movement property, including at least two of amount, speed, acceleration and direction of the movement of the user terminal to be positioned, and the processing system is configured to cause the apparatus to:
calculate a first timing-based positioning result on the basis of the first timing value;
calculate a second timing-based positioning result on the basis of the second timing value;
evaluate probabilities of the first an second timing-based positioning results in accordance with the movement property; and
calculate a final timing-based positioning result for the user equipment to be positioned as au area of probability of the position thereof on the basis of the evaluated probabilities of the calculated first and second timing-based positioning results.

18. (canceled)

19. (canceled)

20. The apparatus according to claim 17, wherein the processing system is configured to cause the apparatus to:
weight the probability of a newer positioning result with a higher weight than the probability of an older positioning result.

21. The apparatus according to claim 17, wherein the processing system is configured to cause the apparatus to:
combine a timing-based positioning result with map information, and
determine the position of the user terminal to be positioned on the basis of the timing-based positioning result such that it is located on a track on a map according to the map information at a track position with highest probability.

22. The apparatus according to claim 17, wherein, the processing system is configured to cause the apparatus to forward the received movement information to at least one of an emergency-related network entity and a public safety-related network entity, and/or
the apparatus is operable as or at a network entity responsible for positioning calculation, and/or
the apparatus is operable as or at a serving mobile location center, and/or
the apparatus is operable in at least one of a LTE and a LTE-A cellular system.

23. (canceled)

24. The method according to claim 6, wherein, when the movement information comprises a non-movement indication, and performing the timing-based positioning calculation comprises:
calculating a first timing-based positioning result on the basis of the first timing value;
calculating a second timing-based positioning result on the basis of the second timing value; and
calculating a final timing-based positioning result for the user equipment to be positioned as an area of probability of the position thereof on the basis of the calculated first and second timing-based positioning results.

25. The apparatus according to claim 17, wherein, when the movement information comprises a non-movement indication, the processing system is configured to cause the apparatus to:
calculate a first timing-based positioning result on the basis of the first timing value;
calculate a second timing-based positioning result on the basis of the second timing value; and
calculate a final timing-based positioning result for the user terminal to be positioned as an area of probability of the position thereof on the basis of the calculated first and second timing-based positioning results.

26. A computer program product comprising a non-transitory computer-readable storage medium having computer readable instructions stored thereon for use in observed time difference of arrival timing-based determination of position of a user equipment of a cellular communication system, the computer readable instructions being executable by a computerized device to cause the computerized device to:
measure a first timing value for timing-based positioning calculation on the basis of a first positioning-related signal at a first time;
measure a second timing value for timing-based positioning calculation on the basis of a second positioning-related signal at a second time;
derive movement information indicative of a movement of the user equipment to be positioned during a time interval from the first time to the second time; and
signal the measured first timing value, the measured second timing value and the derived movement information towards a base station or access node of said system for use in observed time difference of arrival timing-based positioning calculation,
wherein deriving the movement information comprises:
determining a movement measure of the movement of the user equipment to be positioned during the time interval; and
defining the movement information as a non-movement indication when an absolute value of the determined movement measure is equal to or smaller than a movement threshold, and defining the movement information as a movement indication and/or a movement property, including at least two of amount, speed, acceleration and direction of the movement of the user equipment to be positioned, when an absolute value of the determined movement measure is larger than the movement threshold.

27. The computer program product according to claim 26, wherein:
the movement information is derived from sensor data of at least one sensor mounted at the user equipment to be positioned, and
the at least one sensor comprises at least one of an accelerometer sensor, a gyroscope sensor and a magnetometer sensor.

28. The computer program product according to claim 26, wherein:
the first and second positioning-related signals comprise time division signals, and the first and second timing values are measured for different time periods of the first and second positioning-related signals, and/or
the first and second positioning-related signals comprise frequency division signals, and the first and second timing values are measured for different frequency bands of the first and second positioning-related signals.

29. The computer program product according to claim 26, wherein:
the first and second positioning-related signals comprise positioning reference signals from one of a serving cell of the user equipment to be positioned and a neighboring cell of the serving cell, respectively, and/or
the first timing value and/or the second timing value is measured by using one of an intra-frequency or single-carrier measurement, an inter-frequency or multiple-carrier measurement and a measurement on carrier aggregation component, and/or
the computer readable instructions are operable at or by a user equipment, mobile station or modem, and/or
the computer readable instructions are operable at or by a user equipment, mobile station or modem operable in time division duplex or frequency division duplex, and/or
the computer readable instructions are operable in at least one of a LIE and a LTE-A cellular system.

30. A computer program product comprising a non-transitory computer-readable storage medium having computer readable instructions stored thereon for use in observed time difference of arrival timing-based determination of position of a user equipment of a cellular communication system, the computer readable instructions being executable by a computerized device to cause the computerized device to:
receive, from said user equipment, a first timing value for timing-based positioning calculation relating to a first time, a second timing relating to a second time, and movement information indicative of a movement of the user equipment to be positioned during a time interval from the first time to the second time; and
perform observed time difference of arrival timing-based positioning calculation relating to the user equipment to be positioned on the basis of the received first timing value, second timing value, and movement information,
wherein the movement information comprises a movement property, including at least two of amount, speed, acceleration and direction of the movement of the user equipment to be positioned, and performing the timing-based positioning calculation comprises:
calculating a first timing-based positioning result on the basis of the first timing value;
calculating a second timing-based positioning result on the basis of the second timing value;
evaluating probabilities of the first and second timing-based positioning results in accordance with the movement property; and
calculating a final timing-based positioning result for the user equipment to be positioned as an area of probability of the position thereof on the basis of the evaluated probabilities of the calculated first and second timing-based positioning results.

31. The computer program product according to claim 30, wherein, when the movement information comprises a non-movement indication, and performing the timing-based positioning calculation comprises causing the computerized device to:
calculate a first timing-based positioning result on the basis of the first timing value;
calculate a second timing-based positioning result on the basis of the second timing value; and
calculate a final timing-based positioning result for the user equipment to be positioned as an area of probability of the position thereof on the basis of the calculated first and second timing-based positioning results.

32. The computer program product according to claim 30, wherein evaluating the probabilities of the first and second timing-based positioning results comprises causing the computerized device to weight the probability of a newer positioning result with a higher weight than the probability of an older positioning result.

33. The computer program product according to claim 30, wherein performing timing-based positioning calculation comprises causing the computerized device to:
combine a timing-based positioning result with map information; and
determine the position of the user equipment to be positioned on the basis of the timing-based positioning result such that it is located on a track on a map according to the map information at a track position with highest probability.

34. The computer program product according to claim 30, further causing the computerized device to:
forward the received movement information to at least one of an emergency-related network entity and a public safety-related network entity, and/or
the computer readable instructions are operable at or by a network entity responsible for positioning calculation, and/or
the computer readable instructions are operable at or by a serving mobile location center, and/or
the computer readable instructions are operable in at least one of a LTE and a LTE-A cellular system.
